(19) United States
(12) Patent Application Publication
(10) Pub. No.: US 2021/0130076 A1
(43) Pub. Date: May 6, 2021

(54) AUTOMATED PILL DISPENSER AND METHOD OF USING THE SAME

(71) Applicant: Amy Brinckerhoff, Marietta, GA (US)

(72) Inventor: Amy Brinckerhoff, Marietta, GA (US)

(21) Appl. No.: 16/675,096

(22) Filed: Nov. 5, 2019

(51) Int. Cl. B65D 83/04; G08B 21/18

(52) U.S. Cl. CPC B65D 83/04; G08B 21/18

(57) ABSTRACT

An automated pill dispensing device includes a housing containing a rotatable platform on which a series of individual containers rest. A controller manages operations of the automated pill dispending device including rotation of the platform causing pills in said individual containers to drop into a dispensing area where the user may retrieve them. An alarm may activate responsive to the pills remaining in the dispensing area beyond a pre-established time period. The automated pill dispending device may also communicate with a mobile device.

### FIELD OF THE INVENTION

The embodiments of the present invention relate to an automated pill dispenser.

### BACKGROUND

Taking medications, vitamins, supplements and the like (collectively “medications’) on a regular basis can be tedious and often people forget to take them. While some persons place medications in segmented containers or similar articles, such containers do not offer enough certainty that persons will take the medications when required.

It would be advantageous to develop a more reliable and robust automated pill dispenser for assisting persons with taking medications, vitamins, supplements and the like.

### SUMMARY

In one embodiment, an automated pill dispensing device includes a housing containing a rotatable platform on which a series of individual containers rest. A controller manages operations of the automated pill dispending device including rotation of the platform causing pills in said individual containers to drop into a dispensing area where the user may retrieve them. In one embodiment, an alarm activates responsive to said pills remaining in the dispensing area beyond a pre-established time period.

A user interface provides means for the user to set the frequency at which pills are dispensed, the regular times when pills are dispensed and alarm parameters. In one embodiment, the automated device includes a RF transmitter configured to communicate with a mobile device to alert the user that the pills have been dispensed.

In one embodiment, the automated device is no larger than a conventional coffee machine but those skilled in the art will recognize that the size can fluctuate depending on the embodiment and available features.

Other variations, embodiments and features of the present invention will become evident from the following detailed description, drawings and claims.

### BRIEF DESCRIPTION OF THE DRAWINGS

FIG. 1 illustrates a first side view of an automated pill dispenser according to the embodiments of the present invention;

FIG. 2 illustrates a second side view of the automated pill dispenser according to the embodiments of the present invention;

FIG. 3 illustrates a front view of the automated pill dispenser according to the embodiments of the present invention;

FIG. 4 illustrates a rear view of the automated pill dispenser according to the embodiments of the present invention;

FIG. 5 illustrates a bottom view of the automated pill dispenser according to the embodiments of the present invention;

FIG. 6 illustrates a top down view of the automated pill dispenser with a lid open according to the embodiments of the present invention;

FIG. 7 illustrates a front view of the automated pill dispenser with the lid open according to the embodiments of the present invention;

FIG. 8 illustrates a side view of the automated pill dispenser with the lid open according to the embodiments of the present invention;

FIG. 9 illustrates a cross-sectional view of a first dispensing design according to the embodiments of the present invention;

FIGS. 10 and 11 illustrate cross-sectional views of second and third dispensing designs according to the embodiments of the present invention;

FIG. 12 illustrates a front view of the automated pill dispensing device with pills being dispensed according to the embodiments of the present invention;

FIG. 13 illustrates a block diagram of internal components of the automated pill dispending device according to the embodiments of the present invention; and

FIG. 14 illustrates a flow chart detailing operation of the automated pill dispenser according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate the automated pill dispensing device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device. Cloud storage may be used as well.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS, Python, GO or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

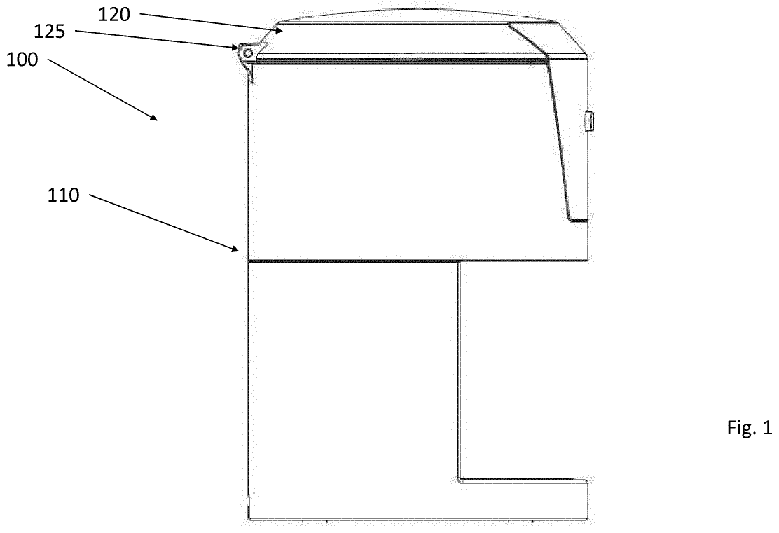

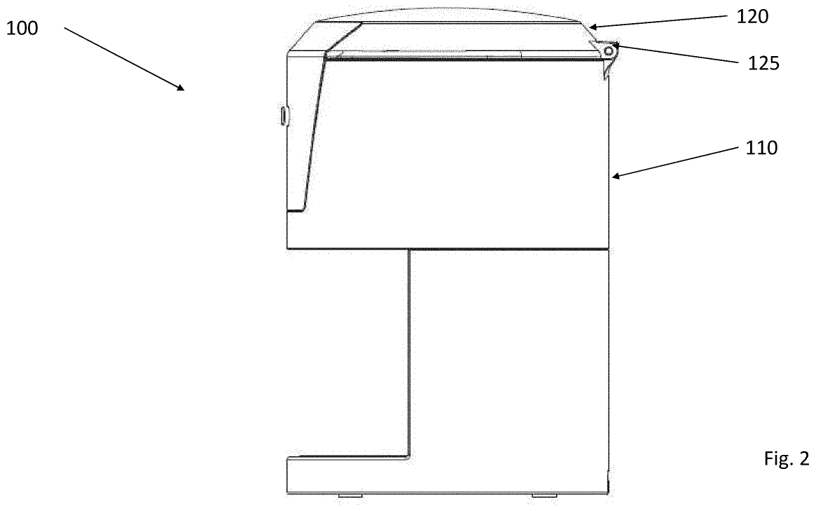

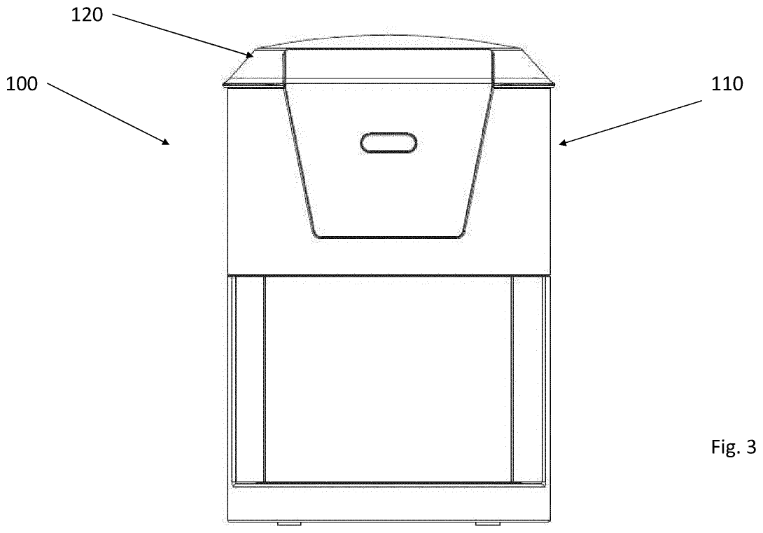

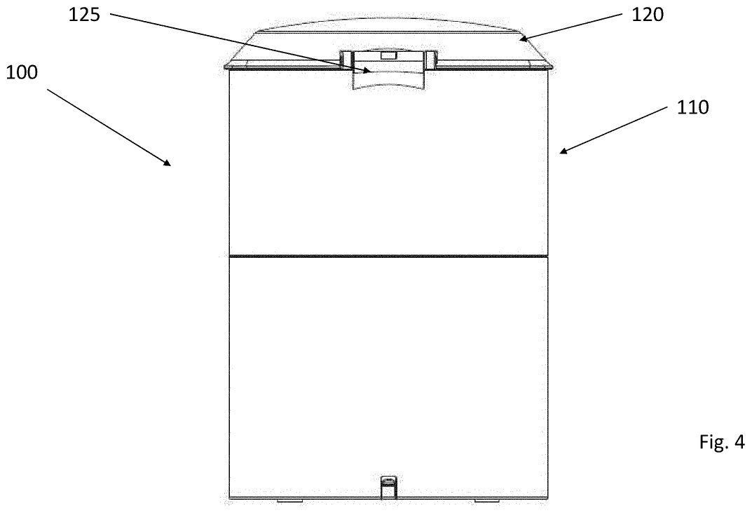

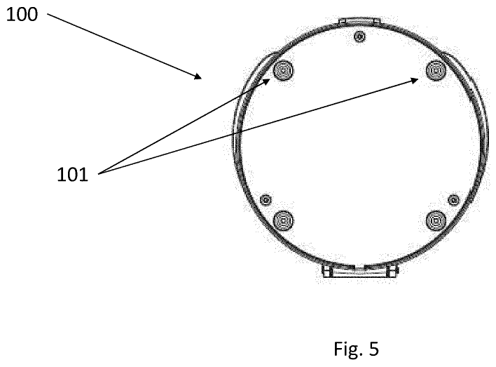

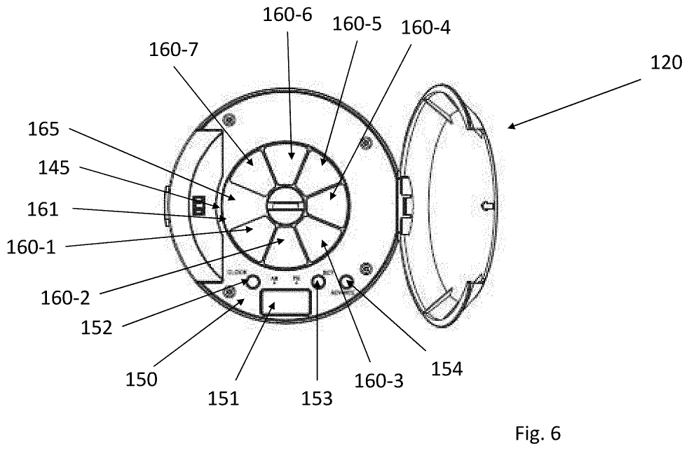

FIGS. 1-4 show various views of an automated pill dispensing device 100 according to the embodiments of the present invention. As used herein, the term “pill” refers to capsules, tablets, pellets, caplets, lozenges, boluses, troches or any similar small masses to be swallowed. The automated pill dispensing device 100 broadly includes a housing 110, lid 120 and pill dispensing area 130. Hinge 125 allows the lid 120 to open revealing an interface 150 (seen in FIG. 6) and pill containers 160-1 through 160-7 (seen in FIG. 6) representing each day of the week. Those skilled in the art will recognize that more or less than seven containers may be incorporated into the automated pill dispensing device 100. FIG. 5 shows a series of supports or feet 101 for maintaining the automated pill dispensing device 100 in position on a flat, rigid surface.

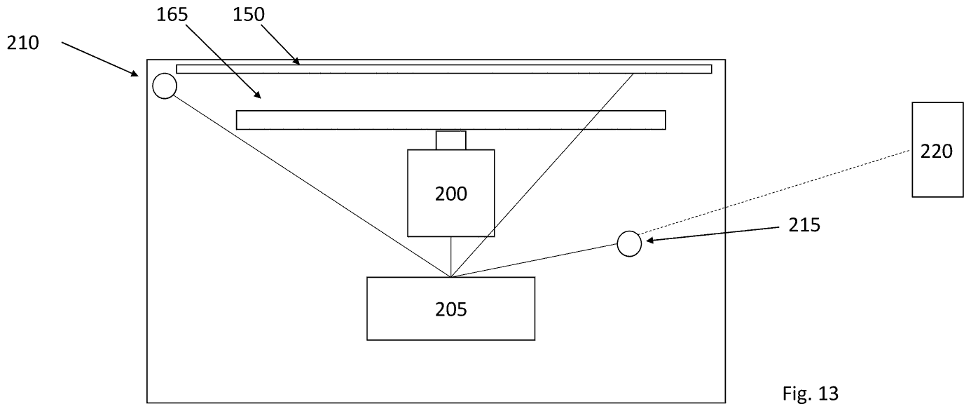

Pill containers 160-1 through 160-7 rest upon a rotatable platform 165. As shown in FIG. 13, a motor 200 communicates with and drives the rotatable platform 165. A controller 205 is programmed to activate the motor 200 according to a schedule input and/or approved by the user via said user interface 150. In one embodiment, the controller 205 is pre-programmed to rotate the platform 165 every 24 hours based on a dispense time input by the user. Thus, if the user sets the dispense time, via the user interface 150, to 8:00 am, the controller 205 causes the platform 165 to rotate at 8:00 am each day.

Rotation of the platform 165 may be monitored by one or more sensors 210 or may be pre-programmed into the controller 205 based on a number and size of the pill containers. In one embodiment, sensor 210 tracks movement of the pill containers and signals the controller 205 to cease rotation of the platform 165 at a desired position. The sensor 210 may be any type including an optical sensor, laser sensor, weight sensor, motion sensor, proximity sensor, IR and RF sensor and so on. Indeed, any sensor configured to detect the location and/or movement of the pill containers 160-1 through 160-7, empty space 161 and/or platform 165 may be used, including cameras and other image capturing devices. In a pre-programmed embodiment, the platform 165 is rotated a pre-established number of degrees based on a number and size of the pill containers. By way of reference, FIG. 6 shows seven pill containers 160-1 through 160-7 and one empty space 161 on the platform 165. Consequently, the controller 205 causes the platform 165 to rotate 45° (360° of circular platform divided by 8 equal units) each time rotation is triggered. Communications between the controller 205 and sensor 210, motor 200 and other components may be wired or wireless.

In another embodiment, a RF transceiver 215 or other type of transceiver is configured to allow communication between the automated pill dispensing device 100 and a mobile device 220 (e.g., smart phone). Such communications allow the user to control, operate and/or program the automated pill dispensing device 100 using the mobile device running an appropriate software application(s). The communications also allow the automated pill dispensing device 100 to communicate information to the user's smart device (e.g., pills dispensed).

Now referring to FIG. 6, the user interface 150 includes a display 151, clock button 152, set button 153 and advance button 154. The clock button 152 and set button 153 provide the user with means to enter a time (e.g., once daily) for pills to be dispensed. Those skilled in the art will understand that the pills may be dispensed in any intervals desired by the user. The advance button 154 provides means for the user to rotate the platform 165 as needed by causing the controller 205 to activate the platform 165.

FIG. 6 shows seven pill containers 160-1 through 160-7 whereby each pill container 160-1 through 160-7 corresponds to a day of the week. The pill containers 160-1 through 160-7 may be separate or all seven pill containers 160-1 through 160-7 may be formed as a single unit.

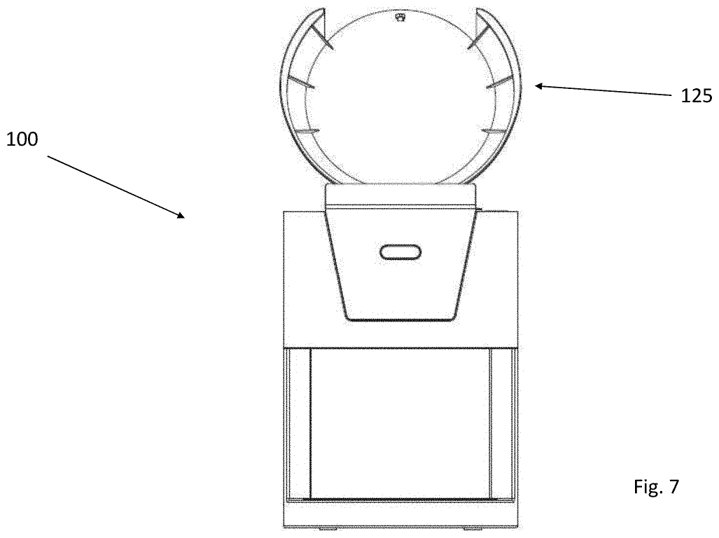

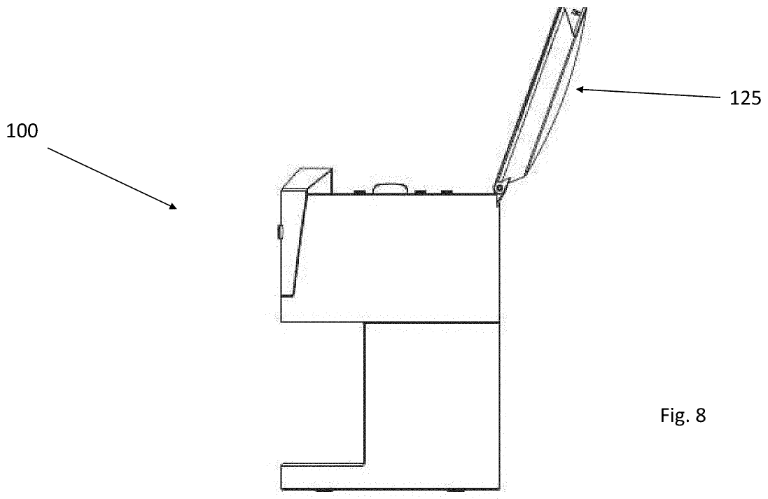

FIGS. 7 and 8 show the automated pill dispending device 100 from the side and front, respectively, with the lid 125 open.

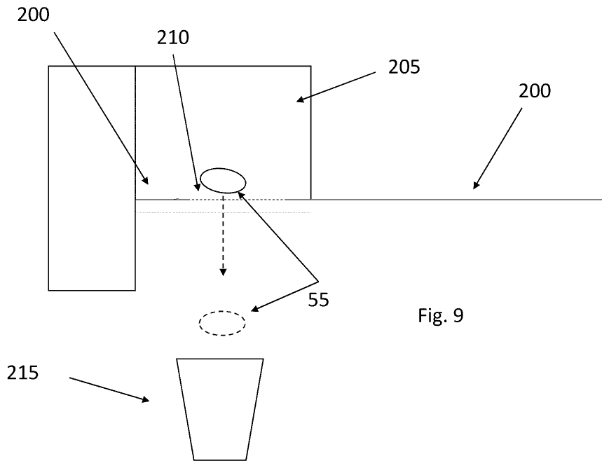

As best seen in FIG. 9, each of the pill containers 205 has no bottom such that pills rest directly on the platform 200. In other words, the containers 205 are comprised of one or more walls only. Platform 200 includes an opening 210 through which pills 50 may drop into cup 215 therebelow. In practice, in this embodiment, the platform 200 is stationary while the pill containers 205 are moved thereon. When a subject pill container 205 aligns with the desired location, the pill(s) 50 in the container drop through the opening 210 into the cup 215.

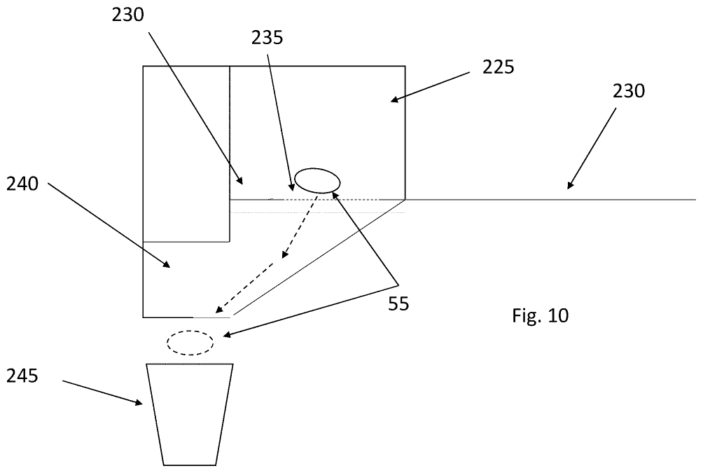

In an alternative embodiment shown in the cross-sectional view of FIG. 10, each of the pill containers 225 has no bottom such that pills rest directly on the platform 230. In this embodiment, the pill containers 225 are moved about the stationary platform 230 until the pill container 225 aligns with an opening 235 in the platform 230 allowing the contained pill(s) 55 to drop through chute 240 into cup 245 therebelow.

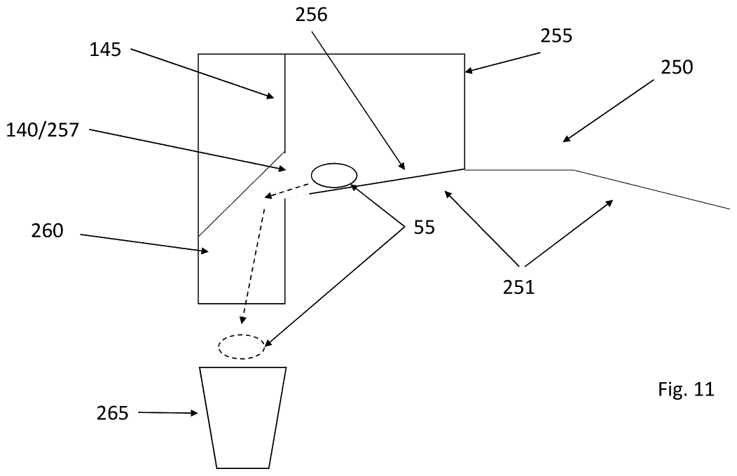

In another embodiment, as shown in FIG. 11, the platform 250 rotates with the pill containers 255 thereon. In this embodiment, the pill containers 255 have a slanted bottom 256 and the platform 250 has a corresponding slanted surface 251. An opening 257 in each container 255 corresponds to an opening 140 in an inner wall 145 circumscribing the platform 250. A chute 260 directs the pill(s) 55 to a cup 265 below. In practice, when openings 257 and 140 align, the pill(s) 55 roll down the slanted bottom of the container 255 into chute 260 and eventually into cup 265.

Those skilled in the art will recognize that, other than those designs shown in FIGS. 9-11, any number of gravity-assisted designs are conceivable without departing from the spirit and scope of the present invention.

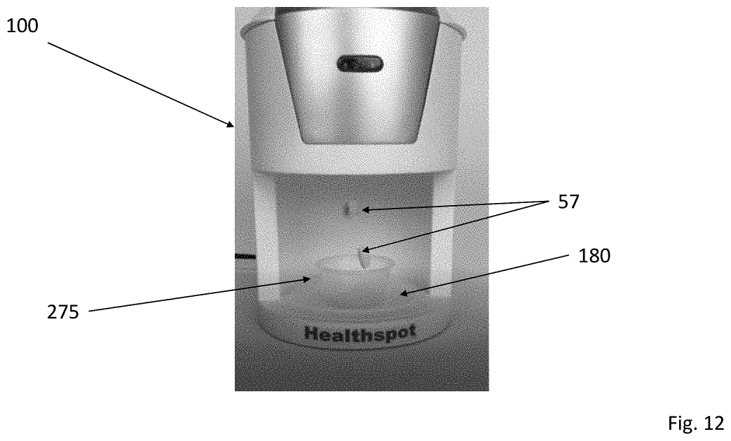

FIG. 12 show a front view of the automated pill dispending device 100 dispending pills 57 into a cup 275. As shown, the cup 275 is placed on support 280 integral with the automated pill dispensing device 100. Alternatively, the automated pill dispensing device 100 does not include the support and the cup 275 may be positioned on the surface supporting the automated pill dispensing device 100.

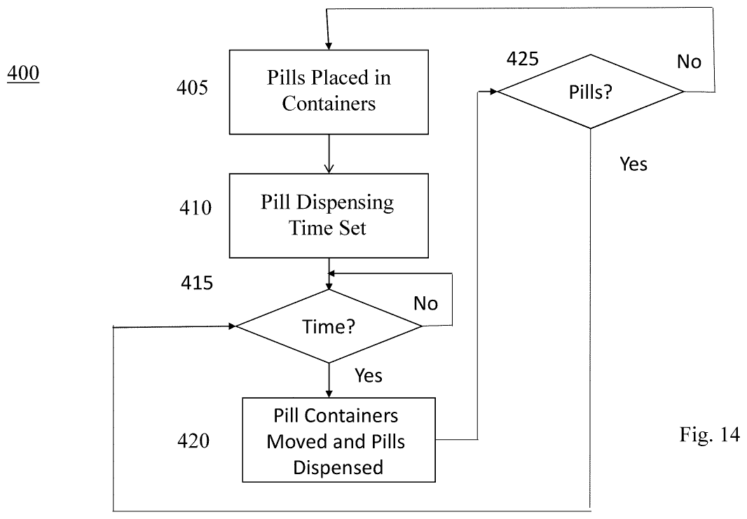

FIG. 14 shows a flow chart 400 detailing one exemplary operation of the automated pill dispenser 100. At 405, pills are placed in the containers. At 410, the time for pill dispensing is set by the user. At 415, it is determined is the time to dispense has arrived. If so, at 420, the pills in the subject container are dispensed in the manner described above. At 425, it is determined if any pills remain in any of the containers. If so, the chart 400 loops back to 415 to determine if the next time to dispense has arrived. If, at 425, it is determined there are no pills remaining in any of the containers, the chart 400 loops back to 405 where the containers are re-filled with pills.

While the detailed description above focuses on dispensing pills, it is conceivable that the automated pill dispensing device may also dispense other items (e.g., pet treats or children's snacks) on a regular basis as set by the user.

Although the invention has been described in detail with reference to several embodiments, additional variations and modifications exist within the scope and spirit of the invention as described and defined in the following claims.

1. An automated pill dispending device comprising:
a housing having an upper portion and a support therebelow collectively defining a space for receipt of an article to capture dispensed pills;
an interface for users to input a scheduled time for dispensing of pills;
a plurality of containers configured to retain said pills;
a platform supporting said plurality of containers;
a motor to drive said platform;
a central controller communicatively linked to said motor;
a movable lid connected to an upper portion of said housing, said movable lid movable between a closed position and an open position, said movable lid concealing said plurality of containers and said interface when in said closed position such that said plurality of containers and said interface are accessible only when said movable lid is in an open position, said interface proximate to said plurality of containers; and
wherein said central controller drives said platform and/or said plurality of containers to successively move each of said plurality of containers to a position allowing contained pills in each of said plurality of containers to be successively dispensed from said plurality of containers based on said scheduled time.

2. The automated pill dispensing device of claim 1 wherein said interface includes one or more of the following: a display, clock button, set button and advance button.

3. The automated pill dispensing device of claim 1 further comprising an alarm.

4. The automated pill dispensing system of claim 1 further comprising a transceiver for communicating with a mobile device.

5. An automated pill dispending device comprising:
a housing having an upper portion and a support therebelow collectively defining a space for receipt of an article to capture dispensed pills;
an interface for users to schedule a frequency for dispensing of pills;
a plurality of containers configured to retain said pills;
a platform supporting said plurality of containers;
a motor to drive said platform;
a central controller communicatively linked to said motor;
a movable lid connected to an upper portion of said housing, said movable lid movable between a closed position and an open position, said movable lid concealing said plurality of containers and said interface when in said closed position such that said plurality of containers and said interface are accessible only when said movable lid is in an open position, said interface proximate to said plurality of containers, said interface proximate to said plurality of containers; and
wherein said central controller drives said platform and/or said plurality of containers to successively move each of said plurality of containers to a position allowing contained pills in each of said plurality of containers to be successively dispensed from said plurality of containers based on said frequency for dispending of pills.

6. The automated pill dispensing device of claim 5 wherein said interface includes one or more of the following: a display, clock button, set button and advance button.

7. The automated pill dispensing device of claim 5 further comprising an alarm.

8. The automated pill dispensing system of claim 5 further comprising a transceiver for communicating with a mobile device.

9. An automated pill dispending system comprising:
a housing having an upper portion and a support therebelow collectively defining a space for receipt of an article to capture dispensed pills;
an interface for users to input a scheduled time for dispensing of pills;
a plurality of containers configured to retain said pills;
a platform supporting said plurality of containers;
a motor to drive said platform;
a central controller communicatively linked to said motor;
a movable lid connected to an upper portion of said housing, said movable lid movable between a closed position and an open position, said movable lid concealing said plurality of containers and said interface when in said closed position such that said plurality of containers and said interface are accessible only when said movable lid is in an open position, said interface proximate to said plurality of containers;
a transceiver for communicating with a mobile device, said mobile device configured to act as a remote interface; and
wherein said central controller drives said platform and/or said plurality of containers to successively move each of said plurality of containers to a position allowing contained pills in each of said plurality of containers to be successively dispensed from said plurality of containers based on said scheduled time.

10. The automated pill dispensing system of claim 9 wherein said interface includes one or more of the following: a display, clock button, set button and advance button.

11. The automated pill dispensing system of claim 9 further comprising an alarm.
